(19) United States
(12) Patent Application Publication
(10) Pub. No.: US 2004/0025024 A1
(43) Pub. Date: Feb. 5, 2004

(54) Information processing apparatus and information processing method

(76) Inventor: Jun Hirai, Tokyo (JP)

Correspondence Address: FROMMER LAWRENCE & HAUG LLP, 745 FIFTH AVENUE, NEW YORK, NY, 10151, US

(21) Appl. No.: 10/623,989

(22) Filed: Jul. 21, 2003

(30) Foreign Application Priority Data
Jul. 22, 2002 (JP) P2002-213007

(51) Int. Cl. H04L 9/00; G06F 17/60

(52) U.S. Cl. 713/176; 380/231; 705/57

(57) ABSTRACT

An information processing apparatus according to the present invention includes a retrieving portion, a communicating portion, a controlling portion, and a storing portion. The retrieving portion retrieves, from an information signal, a detection signal for detecting digital watermark information. The communicating portion transmits the detection signal to another apparatus and receives a processed result for the digital watermark information detected from the detection signal. The controlling portion performs control so as to restrict processing of the information signal, based on the processed result. The storing portion stores the processed result in a manner capable of communicating with another apparatus.

### BACKGROUND OF THE INVENTION

1. Field of the Invention

The present invention relates to an information processing apparatus and an information processing method for processing an information signal, such as a moving-image signal, still-image signal, audio signal, and music signal, based on relevant information that is superimposed on the information signal.

2. Description of the Related Art

Conventionally, with respect to content and the like that are transmitted from broadcast stations and the like via satellite waves, ground waves, and transmission media such as cables, a method for protecting copyrights using so called “digital watermarks” has been proposed. In the method, recording is performed such that a modulated signal or the like of data regarding a copyright is superimposed on a video signal or audio signal at a very low signal level that does not affect the playback of the video signal or audio signal. In the digital network era in which, for example, various types of digital content, such as an image, audio, and data, can be copied in degradation-free conditions, digital watermark technology is a highly effective technology that allows a copyright to be protected by embedding information in content itself.

A technique for realizing a digital watermark for an image signal such as a digital video signal will now be described by way of example. In this case, a case in which a digital watermark is embedded using random-number data in a PN (pseudo-random noise) sequence as a basic pattern based on a statistical property of an image signal will be discussed. For simplicity, the horizontal size is eight pixels and the vertical size is six pixels for frame data of a luminance signal.

First, random-number data PN in a PN sequence is given as Expression 1 below.

$$PN = ( \begin{matrix}+ 1 & - 1 & + 1 & + 1 & - 1 & + 1 & - 1 & - 1 \\ + 1 & + 1 & - 1 & - 1 & - 1 & + 1 & - 1 & + 1 \\ - 1 & + 1 & + 1 & - 1 & + 1 & + 1 & - 1 & + 1 \\ + 1 & - 1 & - 1 & - 1 & + 1 & + 1 & - 1 & - 1 \\ - 1 & - 1 & + 1 & + 1 & + 1 & - 1 & - 1 & + 1 \\ + 1 & + 1 & - 1 & + 1 & - 1 & - 1 & + 1 & - 1\end{matrix} ) \qquad Expression 1$$

This random-number data PN is generated so that the sum total thereof becomes zero statistically. Next, the spectrum of embedded information DC is spread with the random-number data PN having such a property. Thus, when the polarity of the embedded information DC is “1”, the pattern of the random-number data PN is used without being changed, so that a digital watermark pattern WM is given by Expression 2.

$$WM = PN = ( \begin{matrix}+ 1 & - 1 & + 1 & + 1 & - 1 & + 1 & - 1 & - 1 \\ + 1 & + 1 & - 1 & - 1 & - 1 & + 1 & - 1 & + 1 \\ - 1 & + 1 & + 1 & - 1 & + 1 & + 1 & - 1 & + 1 \\ + 1 & - 1 & - 1 & - 1 & + 1 & + 1 & - 1 & - 1 \\ - 1 & - 1 & + 1 & + 1 & + 1 & - 1 & - 1 & + 1 \\ + 1 & + 1 & - 1 & + 1 & - 1 & - 1 & + 1 & - 1\end{matrix} ) \qquad Expression 2$$

Also, when the polarity of the embedded information DC is “0”, an inverted pattern of the random-number data PN is used, so that the digital watermark pattern WM is given by Expression 3 below.

$$WM = - PN = ( \begin{matrix}- 1 & + 1 & - 1 & - 1 & + 1 & - 1 & + 1 & + 1 \\ - 1 & - 1 & + 1 & + 1 & + 1 & - 1 & + 1 & - 1 \\ + 1 & - 1 & - 1 & + 1 & - 1 & - 1 & + 1 & - 1 \\ - 1 & + 1 & + 1 & + 1 & - 1 & - 1 & + 1 & + 1 \\ + 1 & + 1 & - 1 & - 1 & - 1 & + 1 & + 1 & - 1 \\ - 1 & - 1 & + 1 & - 1 & + 1 & + 1 & - 1 & + 1\end{matrix} ) \qquad Expression 3$$

When the embedded information DC is constituted by a plurality of information bits, for example, the frame data of a luminance signal may be divided into appropriate small regions such that individual information bits correspond to respective regions. Also, for example, a plurality of different digital watermark patterns that are perpendicular to each other may be used such that individual information bits correspond to respective digital watermark patterns. Further, those techniques may be used in combination.

Meanwhile, for an image signal such as a digital video signal, suppose that frame data DV1 of a luminance signal is given by Expression 4 because of a property in which adjacent luminance signals have substantially the same pixel values.

$$DV1 = ( \begin{matrix}50 & 51 & 52 & 54 & 52 & 52 & 50 & 49 \\ 49 & 50 & 51 & 53 & 54 & 53 & 50 & 50 \\ 48 & 50 & 50 & 50 & 51 & 52 & 49 & 48 \\ 49 & 49 & 50 & 48 & 49 & 50 & 50 & 49 \\ 48 & 48 & 50 & 49 & 47 & 50 & 52 & 50 \\ 49 & 50 & 52 & 51 & 51 & 52 & 55 & 53\end{matrix} ) \qquad Expression 4$$

A digital watermark can be embedded by adding the digital watermark pattern WM to the frame data DV1 of a luminance signal. When the polarity-of the embedded information DC is “1”, digital-watermark embedded frame data DV2 of a luminance signal is given by Expression 5 below.

$$DV2 = DV1 + WM = ( \begin{matrix}51 & 50 & 53 & 55 & 51 & 53 & 49 & 48 \\ 50 & 51 & 50 & 52 & 53 & 54 & 49 & 51 \\ 47 & 51 & 51 & 49 & 52 & 53 & 48 & 49 \\ 50 & 48 & 49 & 47 & 50 & 51 & 49 & 48 \\ 47 & 47 & 51 & 50 & 48 & 49 & 51 & 51 \\ 50 & 51 & 51 & 52 & 50 & 51 & 56 & 52\end{matrix} ) \qquad Expression 5$$

In order to detect the embedded information DC from the digital-watermark embedded frame data DV2 for a luminance signal as described above, the same random-number data PN in the PN sequence which was used to embed the information DC is used. First, the original frame data DV1 of a luminance signal, the random-number data PN, and an inner product P1 are given by Expression 6 below.

P1=DV1·PN=1 Expression 6

In this case, the inner product P1 is substantially “0” due to a statistical property of pixel signals. In contrast, an inner product P2 of the digital-watermark embedded frame data DV2 of a luminance signal and the random-number data PN is given by Expression 7 below, when the polarity of the embedded information DC is “1”.

P2=DV2·PN=(DV1+WM)·PN=(DV1+PN)·PN=P1+PN²=1+48 Expression 7

Also, when the polarity of the embedded information DC is “0”, the inner product P2 is given by Expression 8 below.

P2=DV2·PN=(DV1+WM)·PN=(DV1−PN)·PN=P1−PN²=1−48 Expression 8

Thus, the absolute value of the inner product P2 is a value in the vicinity of random-number data PN². When the inner product P1 of the original frame data DV1 of a luminance signal and the random-number data PN and the inner product P2 of the digital-watermark embedded frame data DV2 of a luminance signal and the random-number data PN are computed with respect to various images, the distributions of the inner products P1 and P2 can be expressed by predetermined probability density functions. Therefore, as in Expression 9 below, appropriately setting a non-negative threshold TH allows the embedded information DC to be detected from the digital-watermark embedded frame data DV2 of a luminance signal.

P2≦−TH . . . with a digital watermark (polarity “0”)

|P2|<TH . . . without a digital watermark

P2≧TH . . . with a digital watermark (polarity “1”) Expression 9

To realize a digital watermark, two points, i.e., the reliability of digital watermark detection and the influence of a digital watermark on image quality are critical. In order to accurately determine the presence or absence of a digital watermark, the threshold TH must be set so that the probability density function for the above-described case of “with a digital watermark” and the probability density function for the case of “without a digital watermark” are accurately separated. In practice, however, the outskirts of the portability density functions overlap each other, thereby making it difficult to select the threshold TH that allows for accurate determination of the presence or absence of a digital watermark. The probability of determination of “with a digital watermark” even when no digital watermark is embedded is particularly called a “false positive”, and an extremely small false positive is needed to assure sound content distribution. Thus, in order to improve the reliability of digital watermark detection, a non-negative scalar C is used to increase the embedding strength of a digital watermark.

DV2=DV1+CWM Expression 10

P2=DV2·PN=(DV1+CWM)·PN=(DV1±CPN)·PN=P1±CPN² Expression 11

As shown in Expression 11, the inner product P2 of the digital-watermark embedded frame data DV2 of a luminance signal and the random-number data PN may be increased to be sufficiently large.

However, increasing the embedding strength of a digital watermark in that manner provides a considerable influence of the digital watermark on image quality. The reliability of digital watermark detection and the influence of a digital watermark on image quality are in a trade-off relationship.

To minimize the influence of a digital watermark on image quality while ensuring the reliability of digital watermark detection, techniques for embedding a digital watermark by effectively utilizing characteristics of human vision have been proposed. In those techniques, for example, a digital watermark pattern is reallocated in an image or a digital watermark pattern is moved to follow the movement of an image, considering characteristics of human vision. The techniques effectively reduce the influence of the digital watermark on the image quality without changing the overall embedding strength.

Human eyes are sensitive to a change in a low-frequency region such as a flat portion, but are insensitive to a change in a high-frequency region such as an edge portion. This is utilized to reallocate a digital watermark pattern from a more-visible flat portion to a less-visible edge portion, thereby allowing a reduction in the influence of the digital watermark on the image quality while ensuring the reliance of digital watermark detection. Keeping a digital watermark pattern still when an image is still and moving the digital watermark pattern to follow the movement of the image when the image is in motion makes it possible to embed a digital watermark that is difficult to be perceived by human eyes.

In addition, when various attacks, such as image format conversion, digital-to-analog conversion, MPEG (moving picture experts group) compression, filtering, clipping, resizing, rotation, have been made to a digital-watermark embedded image, its embedded digital watermark information must still be correctly detected. One who attempts to fraudulently infringe a copyright can make these attacks to a digital-watermark embedded image with malicious intent. Accordingly, various techniques have been proposed to increase resistance to those attacks and to ensure the reliability of digital watermark detection. However, a digital watermark technique that provides robust resistance against every possible attack has yet to be developed, and thus it is desired to take a prompt action.

The reliability of digital watermark detection and the influence of a digital watermark on image quality are in a trade-off relationship. Thus, increasing the embedding strength of a digital watermark to improve the detection accuracy causes considerable image deterioration, and reducing the embedding strength of a digital watermark to suppress the influence exerted on an image makes it impossible to ensure the detection reliability. While various methods have been proposed for superposition and detection of a digital watermark, a highly-reliable and stable detection characteristic and an image quality characteristic of a level at which image deterioration cannot be perceived have not yet been realized. Thus, there is a need to effectively achieve a method for embedding a digital watermark that realizes both the characteristics described above.

U.S. Pat. No. 5,694,381 discloses a configuration of an information-data playback system having an object of substantially prohibiting copy even when all data of an optical disk is copied. In this configuration, a medium signal, as TOC (table of contents) data, and copy management information, as digital watermark information, are recorded in an optical disk to be played back. When the medium signal indicates a “recordable disk” and the copy management server indicates “copying is prohibited”, a playback prohibition signal becomes “1”, so that the switch circuit is controlled to prevent playback data from being output and to cause error message data to be output. This playback prohibition operation allows the information-data playback system to substantially prohibit copying.

However, while playback restriction using digital watermark information is demanded by information-signal copyright holders, the above-described information-data playback system of the related art suffers from inconvenience in that it is difficult to attach digital-watermark detectors to all information-signal playback apparatuses.

### SUMMARY OF THE INVENTION

Accordingly, the present invention has been made in view of the foregoing, and an object of the present invention is to provide an information processing apparatus and an information processing method which transmit a signal for detecting relevant information included in an information signal to a detection server over a network and which can restrict processing of the information signal based on a processed result for the relevant information detected by the detection server.

An information processing apparatus according to the present invention includes retrieving means for retrieving, from an information signal, a detection signal for detecting digital watermark information; and communicating means for transmitting the detection signal to another apparatus and receiving a processed result for the digital watermark information detected from the detection signal. The information processing apparatus further includes controlling means for performing control so as to restrict processing of the information signal, based on the processed result; and storing means for storing the processed result in a manner capable of communicating with another apparatus.

An information processing method according to the present invention includes a retrieving step of retrieving, from an information signal, a detection signal for detecting digital watermark information; and a communicating step of transmitting the detection signal to another apparatus and receiving a processed result for the digital watermark information detected from the detection signal. The information processing method further includes a controlling step of performing control so as to restrict processing of the information signal, based on the processed result; and a storing step of storing the processed result in a manner capable of communicating with another apparatus.

### BRIEF DESCRIPTION OF THE DRAWINGS

FIG. 1 is a block diagram illustrating an exemplary configuration of a content management system according to an embodiment of the present invention;

FIG. 2 is a block diagram illustrating another exemplary configuration of the content management system;

FIG. 3 is a block diagram illustrating yet another exemplary configuration of the content management system;

FIG. 4 is a block diagram illustrating an exemplary configuration of a recording system;

FIG. 5 is a block diagram illustrating another exemplary configuration of the recording system;

FIG. 6 is a flow chart showing the operation of the content management system;

FIG. 7 is a flow chart showing the operation of restricting copy and playback; and

FIG. 8 is a flow chart showing the operation of storing a watermark detection result.

### DESCRIPTION OF THE PREFERRED EMBODIMENT

An embodiment of the present invention will be described below in detail with reference to the accompanying drawings.

First, a description is given to a case in which relevant information that is superimposed on an information signal played back by a user apparatus 2 from a recording medium is detected by a watermark detection server 3 that is connected to the user apparatus 2 over a network and the information signal in the user apparatus 2 is controlled in accordance with a detection result from the watermark detection server 3.

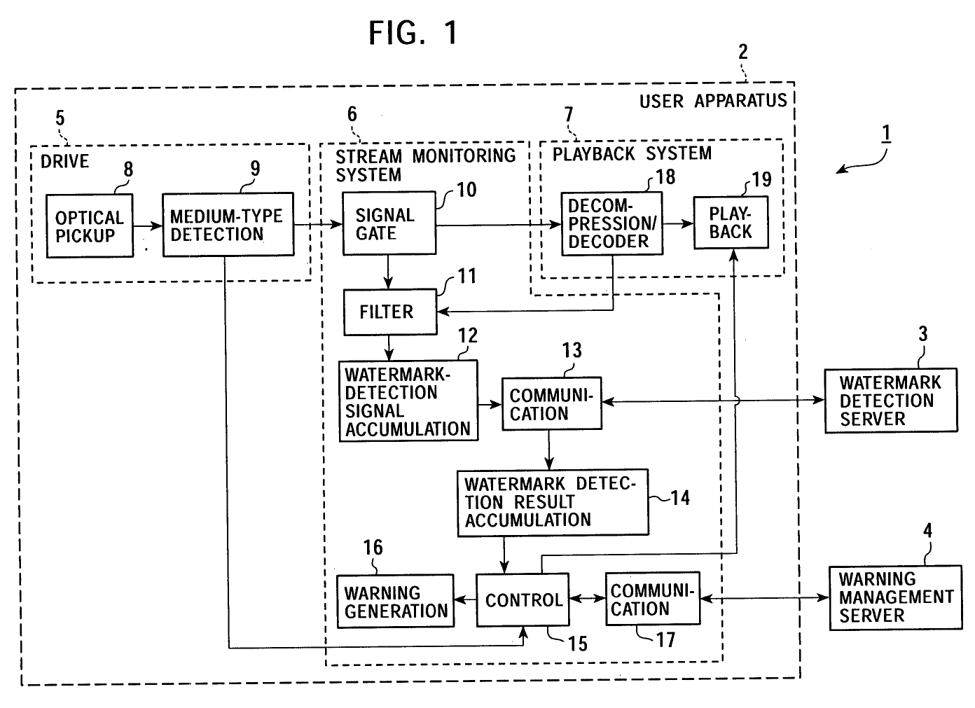

FIG. 1 is a block diagram illustrating an exemplary configuration of a content management system according to an embodiment of the present invention.

Referring to FIG. 1, a content management system 1 includes a user apparatus 2 that processes an information signal in accordance with a detection result of digital watermark information superimposed on the information signal. The digital watermark information is superimposed on the information signal using a scheme as described in the related art.

The content management system 1 also includes a watermark detection server 3 and a warning management server 4, which are connected to the user apparatus 2 over a network. The watermark detection server 3 has communicating means and detecting means. The communicating means receives a signal for detecting digital watermark information (a watermark-information detection signal) from the user apparatus 2, the detecting means detects digital watermark information from the received watermark-information detection signal and obtains a processed result, and the communicating means transmits the processed result to the user apparatus 2. The watermark detection server 3 detects digital watermark information using a scheme as described in the related art.

The warning management server 4 also has communicating means and releasing means. The communicating means receives a processed-result signal from the user apparatus 2 and transmits a signal for removing (clearing) or easing a warning and restriction to the user apparatus 2. The releasing means removes or eases a restriction on processing of an information signal in the user apparatus 2.

The user apparatus 2 includes a drive section 5, a stream monitoring system 6, and a playback system 7. The drive section 5 plays back an information signal from a recording medium, the stream monitoring system 6 monitors the played-back information signal to control the processing, and the playback system 7 performs signal processing on the played-back information signal for playback and output.

The drive section 5 has an optical pickup 8 and a medium-type detection section 9. The optical pickup 8 retrieves an information signal recorded in a disc-shaped recording medium and the medium-type detection section 9 detects the type of disc-shaped recording medium, i.e., whether the recording medium is read only or recordable, based on management information recorded in a TOC (table of contents) area.

The information signal herein refers to, for example, a moving-image data signal, still-image data signal, movie-data-signal, music-data signal, audio-data signal, text-data signal, or computer-program data signal. The recording medium is not limited to a disc-shaped recording medium, and thus may be another type of recording medium, such as a DVD (Digital Versatile Disc), DVHS (Digital Video Home System) tape, DVC (Digital Video Camera) tape, MD (Mini Disc), CD (Compact Disc), BD (Blue-ray Disc), or a semiconductor memory or a hard disk which is configured to allow the information signal in a VHS or 8-mm video format.

The stream monitoring system 6 has a signal gate 10, a filter 11, and a watermark-detection-signal accumulation section 12. The signal gate 10 separates the information signal supplied from the drive section 5 into a signal for the playback system 7 and a signal for watermark detection (a watermark detection signal). The filter 11 retrieves the watermark detection signal and the watermark-detection-signal accumulation section 12 accumulates the watermark detection signal.

The stream monitoring system 6 further has a communication section 13 and a watermark-detection-result accumulation section 14. The communication section 13 transmits the watermark detection signal to the watermark detection server 3 and receives a detection result for digital watermark information detected by the watermark detection server 3. The watermark-detection-result accumulation section 14 stores the detection result for the digital watermark information detected by the watermark detection server 3.

The stream monitoring system 6 further has a communication section 17 that transmits the watermark detection result to the warning management server 4 and receives a warning signal, a processing restriction signal, or a releasing signal which is transmitted from the warning management server 4. The releasing signal is used to remove a warning or restriction.

The stream monitoring system 6 further has a controller 15 and a warning generator 16. The controller 15 restricts the operation of the playback system 7 in the user apparatus 2 to play back an information signal and the warning generator 16 generates a warning when processing is restricted.

The playback system 7 has a decompressing/decoding section 18 and a playback section 19. The decompressing/decoding section 18 decompresses and decodes a compressed information signal and the playback section 19 plays back and outputs the decoded information signal.

Relevant information that is attached as digital watermark information to an information signal herein referrers to, for example, copy control information for an information signal, copyright information, user ID, content ID, date, company name, or right holder's name.

The relevant information may be encoded by spectrum spreading or watermarking such as patch-working.

The watermark-information detection signal is formed to serve as content information for detecting digital watermark information.

The detection signal is also formed to contain a component selected from, of content information for detecting digital watermark information, components needed for detection.

The controller 15 is configured to generate, based on the processed result, a warning when an improper condition for executing processing on an information signal is detected. The improper condition herein refers to, for example, a case in which the information signal has illegal content.

When generating a warning based on the processed result upon detection of an improper condition for executing processing on an information signal, the controller 15 generates a varied warning in accordance with the number of detections of the improper condition.

Also, when an improper condition for executing processing on an information signal is detected, based on the processed result, the controller 15 imposes a restriction on the capability of executing processing on an information signal in accordance with the number of detections of the improper condition.

Further, when an improper condition for executing processing on an information signal is detected, the controller 15 stops the next processing for the information signal, based on a processed result stored in the watermark-detection-result accumulation section 14.

When an improper condition for executing processing on an information signal is detected, the controller 15 imposes a restriction on the capability of processing other information signals in the user apparatus, based on a processed result stored in the watermark-detection-result accumulation section 14.

The detection signal is formed so as to serve as content information for detecting features of content information for detecting digital watermark information or content information for extracting features.

Based on the processed result, when the controller 15 generates a varied warning in accordance with the number of detections of an improper condition for executing processing on an information signal, the warning management server 4 can remove the warning in accordance with a result obtained through communication with the communication section 17.

Based on the processed result, when the controller 15 imposes a restriction on the capability of processing an information signal in accordance with the number of detections of an improper condition for executing processing on an information signal, the warning management server 4 can ease the restriction in accordance with a result obtained through communication with the communication section 17.

During the communication with the warning management server 4, the communication section 17 transmits, to the warning management server 4, an information signal from which an improper condition for executing processing has been detected or information about the supply source of an information signal.

The supply source of an information signal is configured to be a recording medium or another device that transmits an information signal over a network. The recording medium is configured to download and record an information signal transmitted from another device over the network.

When the supply source of an information signal is a recording medium, the controller 15 can impose a restriction on the capability of processing an information signal in accordance with a detection signal indicating the type of recording medium detected by the medium-type detection section 9.

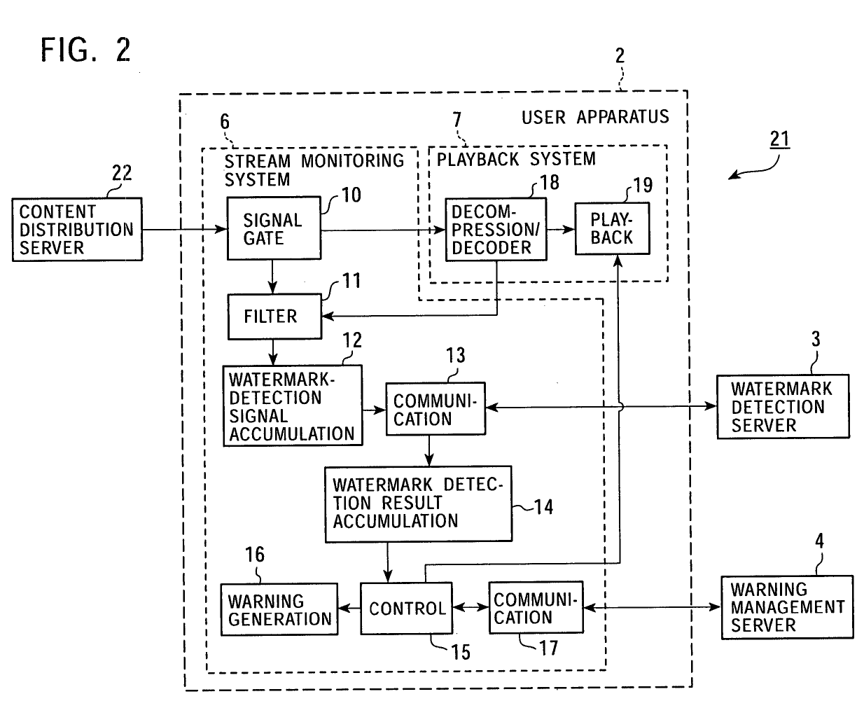

FIG. 2 is a block diagram illustrating an exemplary configuration of the content management system.

Another content management system 21 shown in FIG. 2 is different from the content management system 1 shown in FIG. 1 in that the drive section 5 of the user apparatus 2 in FIG. 1 is replaced with a content distribution server 22 that is connected to the user apparatus 2 over a network. That is, an information signal is supplied to the stream monitoring system 6 from the content distribution server 22 over the network. Since other elements and sections are analogous to those shown in FIG. 1, only different elements and sections will be described and the descriptions of similar elements and sections will be omitted.

Referring to FIG. 2, the content distribution server 22, which is connected to the user apparatus 2 over the network, is configured to supply an information signal to the stream monitoring system 6.

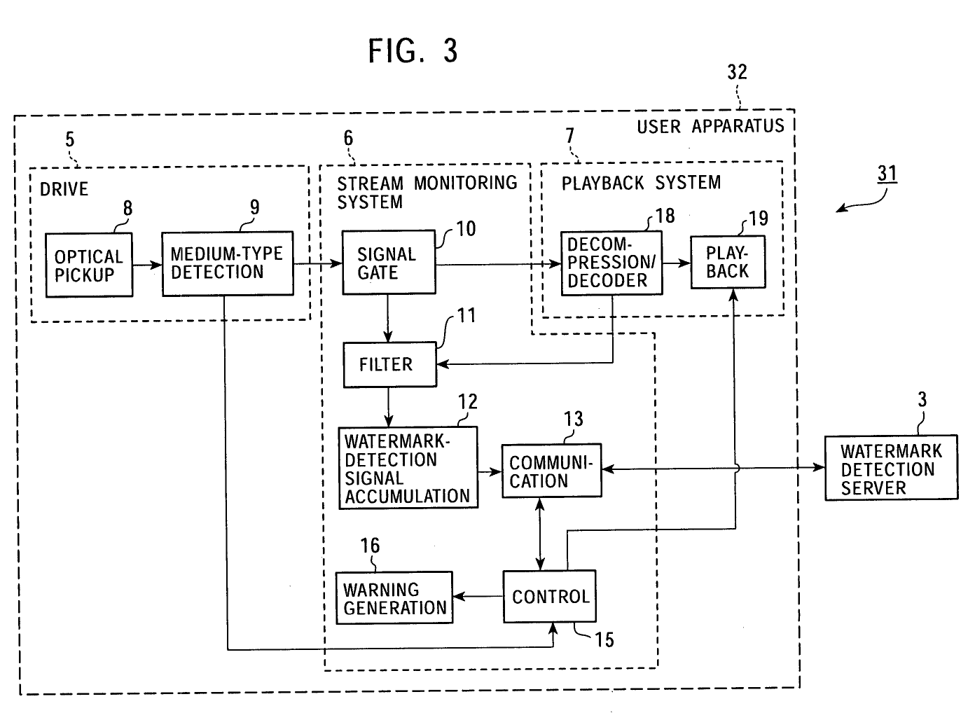

FIG. 3 is a block diagram illustrating an example of the configuration of another content management system.

A content management system 31 shown in FIG. 3 is different from the content management system 1 shown in FIG. 1 in that the communication section 17 of the stream monitoring system 6 in the user apparatus 2 and the warning management server 4 shown in FIG. 1 are eliminated for simplification. Since other elements and sections are analogous to those shown in FIG. 1, the descriptions thereof will be omitted.

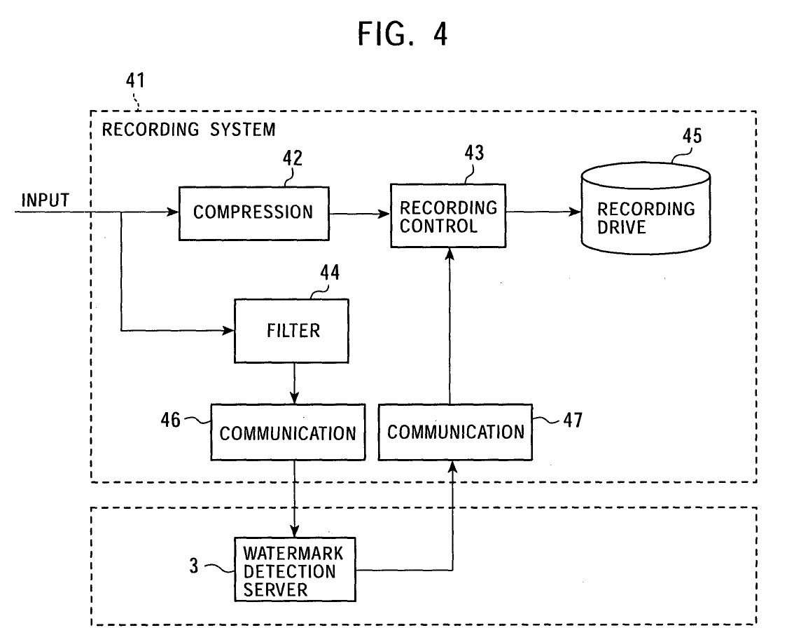

FIG. 4 is a block diagram illustrating the configuration of a recording system.

A recording system 41 shown in FIG. 4 is provided, for example, in parallel to the playback system 7 shown in FIG. 1, to receive an information signal separated by the signal gate 10 of the stream monitoring system 6.

Referring to FIG. 4, the recording system 41 has a filter 44, a communication section 46, and a communication section 47. The filter 44 retrieves a watermark detection signal from an input information signal. The communication section 46 transmits the retrieved watermark detection signal to the watermark detection server 3, and the communication section 47 receives a detection result for digital watermark information detected by the watermark detection server 3.

The recording system 41 further has a compressing section 42, a recording controller 43, and a recording drive 45. The compressing section 42 compresses and encodes an input information signal. The recording controller 43 performs signal processing on the compressed and encoded information signal for recording and controls the recording operation of the recording drive 45, which records the information signal on the recording medium.

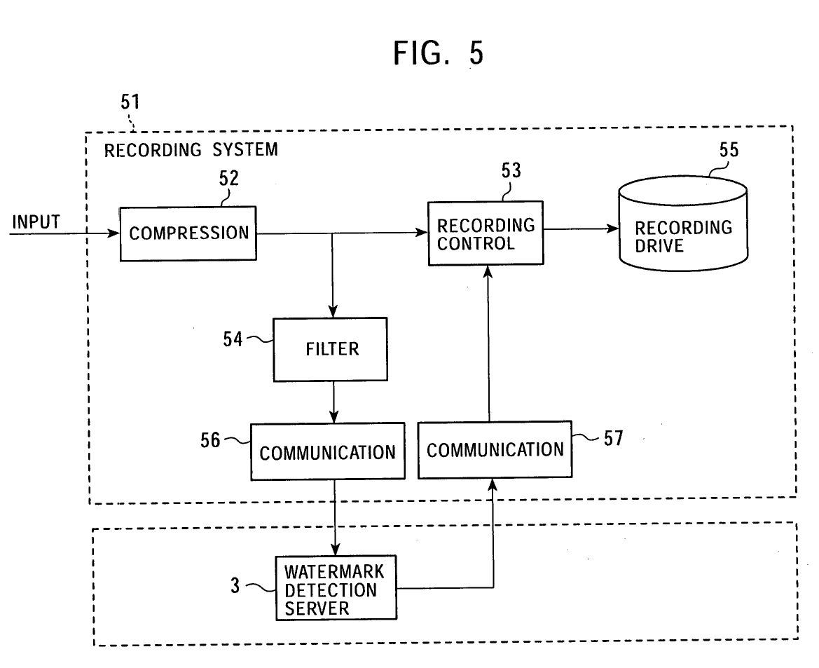

FIG. 5 is a block diagram illustrating the configuration of another recording system. A recording system 51 shown in FIG. 5 is different from the recording system 41 shown in FIG. 4 in that the filter 44 is replaced with a filter 54. That is, while the filter 44 shown in FIG. 4 retrieves a watermark-detection signal from an information signal that has not been compressed and encoded, the filter 54 of the recording system 51 shown in FIG. 5 retrieves a watermark-detection signal from an information signal which has been compressed and encoded.

The recording system 51 shown in FIG. 5 is provided, for example, in parallel to the playback system 7 shown in FIG. 1, to receive an information signal separated by the signal gate 10 of the stream monitoring system 6.

Referring to FIG. 5, the recording system 51 has a compressing section 52, a filter 54, a communication section 56, and a communication section 57. The compressing section 52 compresses and encodes an input information signal and the filter 54 retrieves a watermark-detection signal from the compressed and encoded information signal. The communication section 56 transmits the watermark-detection signal to the watermark detection server 3 and the communication section 57 receives a detection result for digital watermark information detected by the watermark detection server 3.

The recording system 51 further has a recording controller 53 and a recording drive 55. The recording controller 53 performs signal processing on the compressed and encoded information signal for recording and controls the recording operation of the recording drive 55, which records the information signal on the recording medium.

When a user apparatus transmits all information signals for detecting digital watermark information to the watermark detection server 3 connected over a network, a very large load is placed on the network. Accordingly, in the present invention, the filter is used to filter an information signal such that only a watermark-detection signal needed for detecting digital watermark information is retrieved and is transferred to the watermark detection server 3.

A description is now given to the setting of parameters of the filters 44 and 54 for retrieving, from an information signal, a detection signal for detecting digital watermark information.

In this case, when an information signal, for example, in the content management system 21 shown in FIG. 2 is supplied from a recording medium or is transmitted from another signal-source device over the network, the filter 44 or 45 retrieves a detection signal in accordance with the setting of a predetermined parameter. Descriptions below for the setting of parameters are not only particularly applied to the content management system 21 shown in FIG. 2, but can similarly be applied to the content management system 1 shown in FIG. 1.

The predetermined parameter is adapted to selectively set a portion having a high contribution rate to the detection of relevant information based on the detection signal.

The predetermined parameter is adapted to set a frequency band filter that passes a frequency band of the relevant information.

The predetermined parameter is also adapted to set the range of playback time of an information signal on which the relevant information is superimposed.

The predetermined parameter is also adapted to set the range of the frame or field of playback video of an information signal on which the relevant information is superimposed.

The predetermined parameter is also adapted to set the range of pixels for playback video of an information signal on which the relevant information is superimposed.

The predetermined parameter is also adapted to set the level range of a playback signal of an information signal on which the relevant information is superimposed.

The predetermined parameter is also adapted to set the level range of a band-separated playback signal of an information signal on which the relevant information is superimposed.

The predetermined parameter is also adapted to selectively set a conversion factor for compressing and encoding an information signal on which the relevant information is superimposed. In this case, the conversion factor may be appropriately set in accordance with a decoded signal, at the time of decoding, from the decompressing/decoding section 18 of the playback system 7.

The predetermined parameter is adapted to selectively set an I picture (intra picture) of a GOP (group of picture) structure when the information signal on which the relevant information is superimposed is compressed and encoded in compliance with an MEPG-2 (Moving Picture Experts Group 2) standard.

When an attack by someone who attempts to violate the copyright of an information signal is detected based on a detection result from the watermark detection server 3 and an inadequate parameter setting of the filter 11 is found, the parameter setting thereof may be actively changed.

When the controller 15 is late for performing a control operation, such as restricting the operation of the recording system, based on a detection result from the watermark detection server 3, a portion that has been recorded in the recording system by mistake may be erased.

Further, a billing server that is connected to the network may be provided. In such a case, the controller 15 may be configured to change a condition for controlling the operation in accordance with billing for the billing server.

The operation of the content management system configured as described above will now be described.

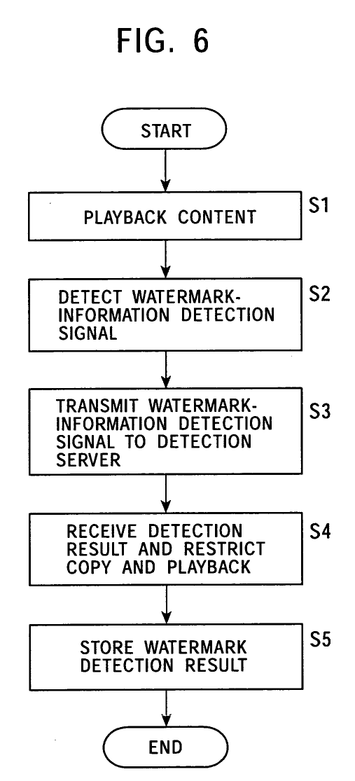

FIG. 6 is a flow chart showing the operation of the content management system. Prior to operation, it is desirable that the drive section 5, the stream monitoring system 6, the recording system 41 or 51, and the playback system 7 in the user apparatus 2 perform authentication with the detection server 3, each other, and all communications be encoded. Further, it is desirable that the content management system be devised so as to prevent a user from tampering therewith.

In step S1, content is played back. Specifically, in the content management system shown in FIG. 1 or 3, the optical pickup 8 of the drive section 5 reads an information signal from a disc-shaped recording medium and supplies the read signal to the medium-type detection section 9. The medium-type detection section 9 supplies, to the controller 15, a type signal representing whether the type of recording medium is read only or readable/writable. The information signal is supplied from the medium-type detection section 9 to the signal gate 10 of the stream monitoring system 6. Also, in the content management system 21 shown in FIG. 2, an information signal transmitted from the content distribution server 22 over the network is received by the stream monitoring system 6 in the user apparatus 2.

In step S2, a watermark-information detection signal is detected. Specifically, the signal gate 10 of the stream monitoring system 6 separates the information signal into an information signal for the playback system 7 and an information signal for the stream monitoring system 6. One information signal from the signal gate 10 is supplied to the filter 11. The filter 11 retrieves a watermark-detection signal out of the information signal and supplies the retrieved watermark-detection signal to the watermark-detection-signal accumulation section 12. Also, in the recording system 41 shown in FIG. 4, the information signal from the signal gate 10 is supplied to the filter 44. The filter 44 retrieves a watermark-detection signal out of the information signal and supplies the retrieved watermark-detection signal to the communication section 46. Also, in the recording system 51 shown in FIG. 5, the information signal from the signal gate 10 is supplied to the compressing section 52 and is compressed and encoded thereby. The compressed and encoded information signal is supplied to the filter 54. The filter 54 retrieves a watermark-detection signal out of the compressed and encoded information signal and supplies the retrieved watermark-detection signal to the communication section 56.

In this case, the filter 11 in the user apparatus 2 samples an information signal for a certain period to retrieve a watermark-detection signal out of the information signal, and transmits the retrieved watermark-detection signal to the watermark detection server 3 over the network, as will be described below. The sampled watermark-detection signal is accumulated in the watermark-detection-signal accumulation section 12 in case that the user apparatus 2 is not connected to the network.

In step S3, the watermark-information detection signal is transmitted to the watermark detection server 3. Specifically, the communication section 13 transmits the watermark-information detection signal to the watermark detection server 3. In the recording system 41 or 51 shown in FIG. 4 or 5, the communication section 46 or 56 transmits the watermark detection signal to the watermark detection server 3. With this arrangement, complicated processing for detecting a watermark is performed by the watermark detection server 3. As a result, the load at the user apparatus 2 is reduced, which can make the internal processing of the user apparatus 2 seamless and speedy.

As described above, when the user apparatus 2 is not connected to the network, a sampled watermark detection signal is accumulated in the watermark-detection-signal accumulation section 12, and once the user apparatus 2 is connected to the network, the sampled watermark detection signal that is accumulated in the watermark-detection-signal accumulation section 12 is automatically transmitted to the watermark detection server 3 so as to ensure that the user cannot stop the transmission from the communication section 13.

In step S4, a detection result is received and the copy and/or playback are restricted. Specifically, the communication section 13 receives a detection result from the watermark detection server 3. The communication section 13 temporarily accumulates the detection result in the watermark-detection-result accumulation section 14. The controller 15 retrieves the detection result from the watermark-detection-result accumulation section 14, and restricts the playback operation of the playback section 19 of the playback system 7 in accordance with the detection result. Also, in the recording systems 41 or 51 shown in FIG. 4 or 5, the communication section 47 or 57 supplies the detection result to the recording controller 43 or 53. In accordance with the detection result, the recording controller 43 or 53 operates so as to restrict the recording operation of a compressed and encoded information signal in the recording drive 45 or 55.

In this case, when the watermark detection server 3 detects a detection result showing that “copying is prohibited”, the information signal is regarded as illegal content. This can be achieved in such a manner that, when watermark information of copy prohibition is embedded in an information signal for typical content by superposition, the information signal is scrambled by a CSS (content scramble system) and thus watermark information is not detected, whereas illegally copied content cannot be scrambled and thus watermark information indicating “copying is prohibited” is detected. Also, when a type of medium that is detected by the medium-type detection section 9 of the drive section 5 is determined to be a recordable medium and watermark information indicating “copying is prohibited” is detected from the recordable medium, the information signal may be regarded as illegal content.

Upon detecting illegal content, the watermark detection server 3 transmits a detection result to the user apparatus 2 and the watermark-detection-result accumulation section 14 in the user apparatus 2 stores the detection result. Thereafter, during the playback of an information signal by the user apparatus 2, when not only the content in question but also any content is played back, a warning is displayed on a monitor. Examples of the warning include “Disk (or data) X played back on month Y day Z has been found to be an illegally copied product. To clear this warning on the monitor, please contact the following”. Upon receiving a response from the user apparatus 2, the warning management server 4 asks the user about releasing condition information, such as a distribution channel of the illegal content, and issues a warning to ensure that the user does not obtain illegal content thereafter. Further, the warning management server 4 transmits a releasing instruction for removing the warning to the user apparatus 2, thereby removing the warning on the monitor.

In step S5, the watermark detection result is stored. Specifically, after performing the control operation, the controller 15 accumulates the detection result and the resulting control operation content in the watermark-detection-result accumulation section 14.

Thus, since means for detecting watermark information is not provided in the user apparatus 2 itself, a load on the stream monitoring system 6 is reduced. Further, since means for detecting watermark information is provided at the watermark detection server 3, means for more advanced detection can be provided. Additionally, the detecting means can be upgraded as the technology progresses, thereby making it possible to cope with attacks by pirates.

In the case in which watermark information is detected by the watermark detection server 3 remotely from the user apparatus 2, when the user apparatus 2 is always connected to the network, there is no problem. However, when the user apparatus 2 is a portable terminal or the like, always-on connection with the network is not guaranteed. Thus, a watermark detection signal is accumulated in the watermark-detection-signal accumulation section 12 of the user apparatus 2 and a watermark detection result is accumulated in the watermark-detection-result accumulation section 14. With this arrangement, when the user apparatus 2 is connected to the network, the watermark detection signal that is stored in the watermark-detection-signal accumulation section 12 is automatically transmitted to the watermark detection server 3. Thus, the watermark detection is only performed by the watermark detection server 3, and the detection result transmitted from the watermark detection server 3 is accumulated in the watermark-detection-result accumulation section 14 and the obtained detection result can be utilized for control.

Conventionally, when illegal content is detected in a disc or the like by detecting a watermark, approaches such as stopping the playback of the illegal content or ejecting the illegal disc from the drive section have been contemplated. On the other hand, in the above-described embodiment, once illegal content is detected, a warning is continuously issued from the warning generator 16 at the user apparatus 2 and the warning cannot be cleared unless the user goes through a releasing procedure with the warning management server 4. Thus, the arrangement is such that the warning from the warning generator 16 cannot be removed only by the user's operation of the user apparatus 2.

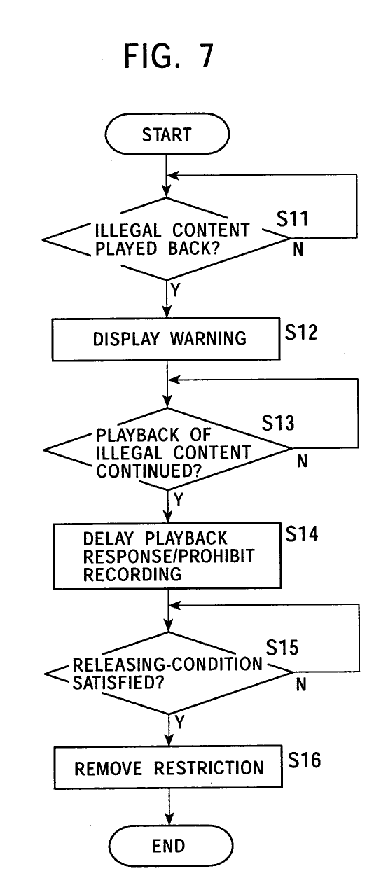

FIG. 7 is a flow chart showing the operation of restricting copy and playback. The flow chart in FIG. 7 also shows a detailed operation of the processing in step S4 in FIG. 6. The main unit that performs the operation shown in FIG. 7 is a controller 15 in the content management system 1, 21, or 31 shown in FIG. 1, 2, or 3. Also, in the case of the recording system 41 or 51 shown in FIG. 4 or 5, the main unit that performs the operation is the recording controller 43 or 53.

In step S11, a determination is made as to whether or not illegal content is played back. Specifically, in the content management systems 1, 21, or 31 shown in FIG. 1, 2, or 3, the controller 15 determines whether or not a detection result, transmitted from the watermark detection server 3 in response to the playback of an information signal, indicates illegal content. Also, in the recording system 41 or 51 shown in FIG. 4 or 5, the recording controller 43 or 53 determines whether or not a detection result, transmitted from the watermark detection server 3 in response to the playback of an information signal, indicates illegal content. Thus, the controller 15 performs the following control not by obtaining control information for a detection result from the watermark detection server 3 in real time but once illegal content is played back.

In step S12, a warning is displayed. Specifically, in the content management system 1, 21, or 31 shown in FIG. 1, 2, or 3, when the controller 15 determines that the detection result, transmitted from the watermark detection server 3 in response to the playback of the information signal, indicates illegal content, the controller 15 controls the warning generator 16 to display a warning. Also, in the recording system 41 or 51 shown in FIG. 4 or 5, when the recording controller 43 or 53 determines that the detection result, transmitted from the watermark detection server 3 in response to the playback of the information signal, indicates illegal content, the recording system 41 or 51 similarly controls the warning generator 16 to display a warning.

In this case, once illegal content is found, the warning is continuously issued and the warning cannot be cleared until the user is connected with the warning management server 4 to receive a releasing signal. The warning displayed on the monitor in this case may be, for example, “Illegal content was played back, please follow the following procedures to clear this warning.”

For playback restriction, a medium-type detection result, sent from the medium-type detection section 9 of the drive section 5, and a water mark detection signal are transmitted from the communication section 13 to the watermark detection server 3 over the network, so that the watermark detection server 3 detects a watermark. In this case, when the watermark detection result indicates that “recording is prohibited” and then the medium-type detection result indicates that “the medium is recordable”, the warning generator 16 issues a warning.

For recording restriction, conventionally, a digital watermark is detected and when the detected watermark indicates “copying is prohibited” or “no more copying is allowed”, the recording is stopped. In addition to this arrangement, in this embodiment, a digital watermark is not detected in real time when recording is performed, and at a point when the user apparatus 2 is connected to the network, the recording controller 43 or 53 performs the recording restriction described above.

In step S13, a determination is made as to whether the playback of the illegal content is continued. Specifically, in the content management system 1, 21, or 31 shown in FIG. 1, 2, or 3, the controller 15 determines whether or not a detection result, transmitted from the watermark detection server 3 in response to continuous playback of the information signal, indicates continuous playback of illegal content. Also, in the recording system 41 or 51 shown in FIG. 4 or 5, the recording controller 43 or 53 determines whether or not a detection result, transmitted from the watermark detection server 3 in response to continuous playback of the information signal, indicates continuous playback of illegal content.

In step S14, the playback response is delayed or the recording is prohibited. Specifically, in the content management system 1, 21, or 31 shown in FIG. 1, 2, or 3, the controller 15 retrieves a detection result from the watermark-detection-result accumulation section 14 and operates so as to delay the response time for the playback operation of the playback section 19 of the playback system 7 in accordance with the detection result. In the recording system 41 or 51 shown in FIG. 4 or 5, the recording controller 43 or 53 operates so as to prohibit the recording operation of a compressed and encoded information signal by the recording drive 45 or 55.

Thus, when the playback of illegal content is continued, the playback and/or recording features are restricted to deter a fraudulent user who attempts to play back illegal content.

In this case, when it is found that the playback of illegal content is repeated, processing, such as scrambling the played-back image, delaying the playback response, or disabling the playback may be performed.

In step S15, a determination is made as to whether a releasing condition is satisfied. Specifically, in the content management system 1, 21, or 31 shown in FIG. 1, 2, or 3, by providing supply-source information of an illegal-content information signal or the illegal-content information signal itself from the user apparatus 2 to releasing means of the warning management server 4, the controller 15 determines whether releasing information for removing, or easing information for easing, the restriction on processing of an information signal in the user apparatus 2 is supplied from the releasing means of the warning management server 4. Also, in the content management system 41 or 51 shown in FIG. 4 or 5, similarly, by providing supply-source information of an illegal-content information signal or the illegal-content information signal itself from the user apparatus 2 to the releasing means of the warning management server 4, the recording controller 43 or 53 determines whether releasing information for removing, or easing information for easing, the restriction on processing of an information signal in the user apparatus 2 is supplied from the releasing means of the warning management server 4.

As the releasing condition, one or a plurality of conditions is selected from, for example, information about a store that distributed the illegal content, the illegal content itself, and the like.

In step S16, the restriction is removed. Specifically, in the content management system 1, 21, or 31 shown in FIG. 1, 2, or 3, by providing the supply source information of an illegal-content information signal or the illegal-content information signal itself from the user apparatus 2 to the releasing means of the warning management server 4, when the controller 15 determines that releasing information for removing, or easing information for easing, the restriction on processing of an information signal in the user apparatus 2 is supplied from the releasing means of the warning management server 4, the controller 15 retrieves the detection result from the watermark-detection-result accumulation section 14 and removes or eases the restriction of delaying the response time of the playback operation of the playback section 19 of the playback system 7 in accordance with the retrieved detection result. Also, in the content management system 41 or 51 shown in FIG. 4 or 5, similarly, by providing the supply-source information of an illegal-content information signal or the illegal-content information signal itself from the user apparatus 2 to the releasing means of the warning management server 4, when the recording controller 43 or 53 determines that releasing information for removing, or easing information for easing, the restriction on processing of an information signal in the user apparatus 2 is supplied from the releasing means of the warning management server 4, the recording controller 43 or 53 removes or eases the restriction of prohibiting the recording operation of the compressed and encoded information signal by the recording drive 45 or 55.

When the above-described releasing condition is satisfied, the restriction on the processing of an information signal can be removed or eased. The restriction may also be removed in such a manner that the warning management server 4 securely communicates with the user apparatus 2 by a scheme such as encryption, for example, to control the playback section 19 that is under restriction. The removing or easing operation of restriction by the warning management server 4 may be requested by a copyright holder or may be performed by a copy holder directly.

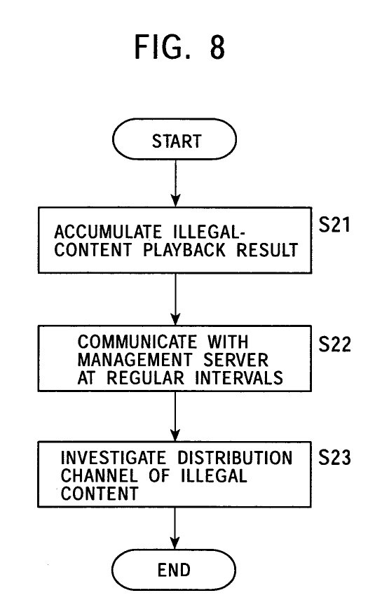

FIG. 8 is a flow chart showing the operation of storing the watermark detection result. The flow chart in FIG. 8 also shows a detailed operation of the processing in step S5 in FIG. 6. The main unit that performs the operation shown in FIG. 8 is a controller 15 in the content management system 1, 21, or 31 shown in FIG. 1, 2, or 3. Also, in the case of the recording system 41 or 51 shown in FIG. 4 or 5, the main unit that performs the operation is the recording controller 43 or 53.

In step S21, the result of playback of illegal content is accumulated. Specifically, in the content management system 1, 21, or 31 shown in FIG. 1, 2, or 3, after performing the control operation, the controller 15 accumulates a detection result and the resulting control operation content in the watermark-detection-result accumulation section 14. Also, in the recording system 41 or 51 shown in FIG. 4 or 5, similarly, after performing the control operation, the recording controller 43 or 53 accumulates the detection result and the resulting control operation content in the watermark-detection-result accumulation section 14.

In step S22, communication is performed with the management server 4 at regular intervals. Specifically, in the content management system 1, 21, or 31 shown in FIG. 1, 2, or 3, the controller 15 accumulates a detection result, obtained from the playback of illegal content, and releasing information or easing information in the watermark-detection-result accumulation section 14 and communicates with the warning management server 4 per month or year. Similarly, in the recording system 41 or 51 shown in FIG. 4 or 5, the recording controller 43 or 53 accumulates a detection result, obtained from the playback of illegal content, and releasing information or easing information in the watermark-detection-result accumulation section 14 and communicates with the warning management server 4 per month or year.

In this manner, according to the present invention, the control is not performed by obtaining control information for a detection result from the watermark detection server 3 in real time. Thus, even when the user apparatus 2 is not always connected to the network, the control can be performed at a point when the user apparatus 2 is connected to the network. In this case, the communicating means for the communication section 13 or 17 may perform communication by directly connecting to the network or a telephone line or may perform communication via a personal computer that is connected to the network using a recordable disc-shaped recording medium or an IC card recording medium.

In step S23, a distribution channel of the illegal content is investigated. Specifically, in the content management system 1, 21, or 31 shown in FIG. 1, 2, or 3, when a distribution channel of the illegal content is determined from the result accumulated in the watermark-detection-result accumulation section 14, the controller 15 reports the distribution channel to the warning management server 4. Also, in the recording system 41 or 51 shown in FIG. 4 or 5, when a distribution channel of the illegal content is determined from the result accumulated in the watermark-detection-result accumulation section 14, the recording controller 43 or 53 reports the distribution channel to the warning management server 4.

Further, depending on the type of recording medium in the drive section 5, the control may be performed as follows. First, when a recording medium in the drive section 5 of the user apparatus 2 is a write-once medium, a rehearsal mode may be provided such that the recording system 41 or 51 starts recording after the controller 15 performs a determination based on a watermark detection result from the watermark detection server 3.

Second, when a recording medium in the drive section 5 of the user apparatus 2 can use a medium-unique code, the recording medium-unique code may be used for control. In this case, while the controller 15 temporarily permits the recording system 41 or 51 to perform recording, when a detection result for a digital watermark subsequently indicates “copying is prohibited” or “no more copying is allowed”, the medium-unique code with which the detection result is detected is registered in a storing means in the user apparatus 2, and thereafter, the playback by the playback section may be disabled until the registered content is erased. In addition, the arrangement may be such that the medium-unique code is registered in the storing means of the warning management server 4 and the playback by the playback section of the user apparatus 2, connected to the network, can be disabled.

Third, in a case in which a recording medium in the drive section 5 of the user apparatus 2 cannot use a medium-unique code, when the controller 15 causes the recording system 41 or 51 to execute recording onto the recording medium, the serial number of the recording medium may be recorded to serve as a unique code in the user apparatus 2. In addition, the above-described scheme may be combined with the serial number of the user apparatus 2. In such a case, as in the second case, the arrangement may be such that the unique code may be registered in the storing means of the warning management server 4 so that the playback by the playback section of user apparatus 2, connected to the network, can be disabled.

Fourth, in a case in which the user apparatus 2 can obtain other copy control information of, for example, CGMS/A (Copy Generation Management System/Analog), CGMS/D (Copy Generation Management System/Digital), or APS (Analog Protection System), when the controller 15 determines that the copy control information has stricter copy restriction than the digital watermark detection result, it is suspected that the content is illegally copied. In this case, a warning is issued from the warning generator 16 in the same manner as for the playback restriction described above, and if such a situation continues, the playback response may be delayed or a function may be restricted so as to deter the fraudulent user from recording the illegal content.

When discrepancies are occurring in multiple types of copy control information including watermark information, the user may be regarded as a user who is very likely to use an illegal user apparatus 2 so that stricter control, such as increasing the number of communications with the watermark detection server 3, is performed.

According to the embodiment described above, there is no need for the recording device or playback device to internally detect a digital watermark, which can reduce a load on the user apparatus. In addition, since means for detecting watermark information is not provided at the user apparatus 2, if a fraudulent user should record or playback illegal content, a load on the stream monitoring system 6 can be reduced. Further, since the means for detecting watermark information is provided at the watermark detection server 3, it is possible to cope with recording and playback of illegal content by the fraudulent user and to provide means for more advance detection. Additionally, the detecting means can be upgraded as the technology progresses, thereby making it possible to cope with attacks by pirates.

When watermark information is detected by the watermark detection server 3 remotely from the user apparatus 2, the watermark-detection-signal accumulation section 12 of the user apparatus 2 accumulates a watermark detection signal and the watermark-detection-result accumulation section 14 accumulates a watermark detection result. With this arrangement, when the user apparatus 2 is connected to the network, the watermark detection signal that is stored in the watermark-detection-signal accumulation section 12 is automatically transmitted to the watermark detection server 3. Thus, the watermark detection is only performed by the watermark detection server 3, and the detection result transmitted from the watermark detection server 3 is accumulated in the watermark-detection-result accumulation section 14 and the obtained detection result can be utilized for control.

What is claimed is:

1. An information processing apparatus, comprising:
retrieving means for retrieving, from an information signal, a detection signal for detecting digital watermark information;
communicating means for transmitting the detection signal to another apparatus and receiving a processed result for the digital watermark information detected from the detection signal;
controlling means for performing control so as to restrict processing of the information signal, based on the processed result; and
storing means for storing the processed result in a manner capable of communicating with another apparatus.

2. An information processing apparatus according to claim 1, wherein the detection signal comprises a component selected from, of content information for detecting the digital watermark information, components needed for the detection.

3. An information processing apparatus according to claim 1, wherein the controlling means generates a warning when an improper condition for executing processing on the information signal is detected based on the processed result.

4. An information processing apparatus according to claim 3, wherein the controlling means generates a varied warning in accordance with the number of detections of the improper condition.

5. An information processing apparatus according to claim 1, wherein, when an improper condition for executing processing on the information signal is detected based on the processed result, the controlling means imposes a restriction on a capability of processing the information signal in accordance with the number of detections of the improper condition.

6. An information processing apparatus according to claim 1, wherein the retrieving means retrieves the detection signal in accordance with the setting of a predetermined parameter.

7. An information processing apparatus according to claim 6, wherein the predetermined parameter selectively sets a portion having a high distribution rate to the detection of relevant information based on the detection signal.

8. An information processing apparatus according to claim 6, wherein the predetermined parameter sets a frequency band filter that passes a frequency band of relevant information.

9. An information processing apparatus according to claim 6, wherein the predetermined parameter sets the range of playback time of an information signal on which relevant information is superimposed.

10. An information processing apparatus according to claim 6, wherein the predetermined parameter sets the range of a frame or field of playback video of an information signal on which relevant information is superimposed.

11. An information processing apparatus according to claim 6, wherein the predetermined parameter sets the range of pixels for playback video of an information signal on which relevant information is superimposed.

12. An information processing apparatus according to claim 6, wherein the predetermined parameter sets a level range of a playback signal of an information signal on which relevant information is superimposed.

13. An information processing apparatus according to claim 6, wherein the predetermined parameter sets a level range of a band-separated playback signal of an information signal on which relevant information is superimposed.

14. An information processing apparatus according to claim 6, wherein the predetermined parameter selectively sets an intra picture of a group-of-picture structure when an information signal on which relevant information is superimposed is compressed and encoded in compliance with a motion picture experts group 2 standard.

15. An information processing method, comprising:
a retrieving step of retrieving, from an information signal, a detection signal for detecting digital watermark information;
a communicating step of transmitting the detection signal to another apparatus and receiving a processed result for the digital watermark information detected from the detection signal;
a controlling step of performing control so as to restrict processing of the information signal, based on the processed result; and
a storing step of storing the processed result in a manner capable of communicating with another apparatus.

16. An information processing method according to claim 15, wherein the detection signal comprises a component selected from, of content information for detecting the digital watermark information, components needed for the detection.

17. An information processing method according to claim 15, wherein the controlling step generates a warning when an improper condition for executing processing on the information signal is detected based on the processed result.

18. An information processing method according to claim 17, wherein the controlling step generates a varied warning in accordance with the number of detections of the improper condition.

19. An information processing method according to claim 15, wherein, when an improper condition for executing processing on the information signal is detected based on the processed result, the controlling step imposes a restriction on a capability of processing the information signal in accordance with the number of detections of the improper condition.

20. An information processing method according to claim 15, wherein the retrieving step retrieves the detection signal in accordance with the setting of a predetermined parameter.

21. An information processing method according to claim 20, wherein the predetermined parameter selectively sets a portion having a high distribution rate to the detection of relevant information based on the detection signal.

22. An information processing method according to claim 20, wherein the predetermined parameter sets a frequency band filter that passes a frequency band of relevant information.

23. An information processing method according to claim 20, wherein the predetermined parameter sets the range of playback time of an information signal on which relevant information is superimposed.

24. An information processing method according to claim 20, wherein the predetermined parameter sets the range of a frame or field of playback video of an information signal on which relevant information is superimposed.

25. An information processing method according to claim 20, wherein the predetermined parameter sets the range of pixels for playback video of an information signal on which relevant information is superimposed.

26. An information processing method according to claim 20, wherein the predetermined parameter sets a level range of a playback signal of an information signal on which relevant information is superimposed.

27. An information processing method according to claim 20, wherein the predetermined parameter sets a level range of a band-separated playback signal of an information signal on which relevant information is superimposed.

28. An information processing method according to claim 20, wherein the predetermined parameter selectively sets an intra picture of a group-of-picture structure when an information signal on which relevant information is superimposed is compressed and encoded in compliance with a motion picture experts group 2 standard.
